(19) United States
(12) Patent Application Publication
(10) Pub. No.: US 2025/0253972 A1
(43) Pub. Date: Aug. 7, 2025

(54) INTELLIGENT CARRIER AGGREGATION FOR MULTISERVICE USER EQUIPMENT

(71) Applicant: Dell Products L.P., Round Rock, TX (US)

(72) Inventors: Medhat Mohammed Khalifa, Giza (EG); Abdulrahman Darwish, Cairo (EG); Abdullah Mohamed, Cairo (EG); Joy Amir, Nasr City (EG); Joyce Tawfik, Heliopolis (EG)

(21) Appl. No.: 18/432,273

(22) Filed: Feb. 5, 2024

(51) Int. Cl. H04L 1/00

(52) U.S. Cl. CPC H04L 1/0006

(57) ABSTRACT

The technology described herein is directed towards a carrier aggregation system for a user equipment requesting simultaneous voice and data sessions. In one example, a classification model determines whether carrier aggregation, if used in conjunction with voice quality data, will likely result in acceptable or unacceptable voice quality for a user equipment, based on dynamic user equipment-related and cell-related input data. If voice quality is deemed acceptable by the model, carrier aggregation is allowed to be used simultaneously (and activated if not in use) with voice service. If voice quality is deemed unacceptable, carrier aggregation is not allowed to be used simultaneously with voice service, (and released if currently in use). Monitoring is performed to evaluate whether subsequent conditions (updated input data) change, such as if estimated voice quality degrades such that carrier aggregation is no longer allowed to continue when both carrier aggregation and voice are otherwise in use.

### BACKGROUND

Carrier aggregation in existing communication networks enables user equipment to use multiple component carriers simultaneously, which enhances data rates and network capacity. While carrier aggregation benefits data services, carrier aggregation can adversely impact voice service performance, depending on network configuration and current traffic conditions. The impact can be seen through factors such as increased interference, limited user equipment uplink power, suboptimal resource allocation, and network congestion.

### BRIEF DESCRIPTION OF THE DRAWINGS

The technology described herein is illustrated by way of example and not limited in the accompanying figures in which like reference numerals indicate similar elements and in which:

FIG. 1 is an example block diagram representation of a system/architecture for determining whether carrier aggregation is to be used with voice service, in accordance with various example embodiments and implementations of the subject disclosure.

FIG. 2 shows an example block diagram representation of a trained classification model that determines whether carrier aggregation (CA) is to be used with voice service based on current user equipment state data and cell-related input data, in accordance with various example embodiments and implementations of the subject disclosure.

FIGS. 3 and 4 comprise a sequence/dataflow diagram that determines whether a user equipment currently using carrier aggregation and preparing to use voice service is allowed to continue using carrier aggregation based on expected voice quality data, in accordance with various example embodiments and implementations of the subject disclosure.

FIGS. 5 and 6 comprise a sequence/dataflow diagram that determines whether a user equipment currently using voice service is to be configured for simultaneous carrier aggregation for data services, based on expected voice quality data, in accordance with various example embodiments and implementations of the subject disclosure.

FIGS. 7 and 8 comprise a sequence/dataflow diagram that determines whether a user equipment currently using voice service and simultaneous carrier aggregation is allowed to continue using carrier aggregation based on expected voice quality data, in accordance with various example embodiments and implementations of the subject disclosure.

FIG. 9 is a flow diagram showing example operations related to determining whether carrier aggregation can be used in conjunction with voice service, in accordance with various example embodiments and implementations of the subject disclosure.

FIG. 10 is a flow diagram showing example operations related to determining, an operating state of carrier aggregation with respect to user equipment based on user equipment state data, primary cell data associated with a primary cell, and secondary cell data associated with a secondary cell, in accordance with various example embodiments and implementations of the subject disclosure.

FIG. 11 is a flow diagram showing example operations related to determining an operating state of carrier aggregation for a user equipment based on output data, corresponding to voice quality data, from a trained model, in accordance with various example embodiments and implementations of the subject disclosure.

FIGS. 12 and 13 comprise a flow diagram showing example operations related to determining whether to allow carrier aggregation to operate in conjunction with voice service based on inputting user equipment state data, primary cell data and secondary cell data into a trained classification model, in accordance with various example embodiments and implementations of the subject disclosure.

FIG. 14 is a block diagram representing an example computing environment into which example embodiments of the subject matter described herein may be incorporated.

FIG. 15 depicts an example schematic block diagram of a computing environment with which the disclosed subject matter can interact/be implemented at least in part, in accordance with various example embodiments and implementations of the subject disclosure.

### DETAILED DESCRIPTION

Various example embodiments of the technology described herein are generally directed towards proactive carrier aggregation management for user equipment requesting simultaneous voice and data sessions. In one example implementation, various user equipment current state data along with primary and secondary cell-related data as described herein is input into a trained classification model that determines whether carrier aggregation, if used in conjunction with voice quality data, will result in acceptable or unacceptable voice quality. If voice quality is deemed acceptable by the model, carrier aggregation is allowed to be used simultaneously with voice service, e.g., allowed to continue if already in use, or configured for use if not currently in use. Conversely, if voice quality is deemed to be unacceptable by the model, carrier aggregation is not allowed to be used simultaneously with voice service, e.g., released if currently in use, or remaining not in use at this time.

Monitoring is performed to evaluate for a change in conditions that can change whether carrier aggregation is allowed to continue when both carrier aggregation and voice are currently being used in conjunction with one another. Monitoring can also be performed to evaluate for a change in conditions that can change whether carrier aggregation is allowed to be activated when only voice service is currently being used.

Thus, in one or more example implementations, a trained model makes a dynamic, intelligent decision as to carrier aggregation usage (activation or release) based on real-time network and user equipment (UE) key performance indicators (KPIs) corresponding to voice quality data. The trained model can be a binary classification model trained in a supervised training process with labeled training data, which can be evaluated with respect to a defined voice quality threshold, e.g., defined by an operator.

Once trained, the classification model operates in inference mode based on inputting near real time network and user equipment key performance indicators. In one or more example implementations, the trained model can be operated in a multi-vendor open radio access network (O-RAN)-compliant system, e.g., as an extended application (xApp) in a controller (near-real time radio access network intelligent control, or RIC layer) to make the decisions.

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. It also should be noted that terms used herein, such as “optimize,” “optimization,” “optimal” and the like only represent objectives to move towards a more optimal state, rather than necessarily obtaining ideal results. For example, “optimal” can mean the highest performing entity of what is available, rather than necessarily achieving a fully optimal result. Similarly, “maximize” means moving towards a maximal state (e.g., up to some threshold limit, if any), rather than necessarily achieving such a state.

Example embodiments of the subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

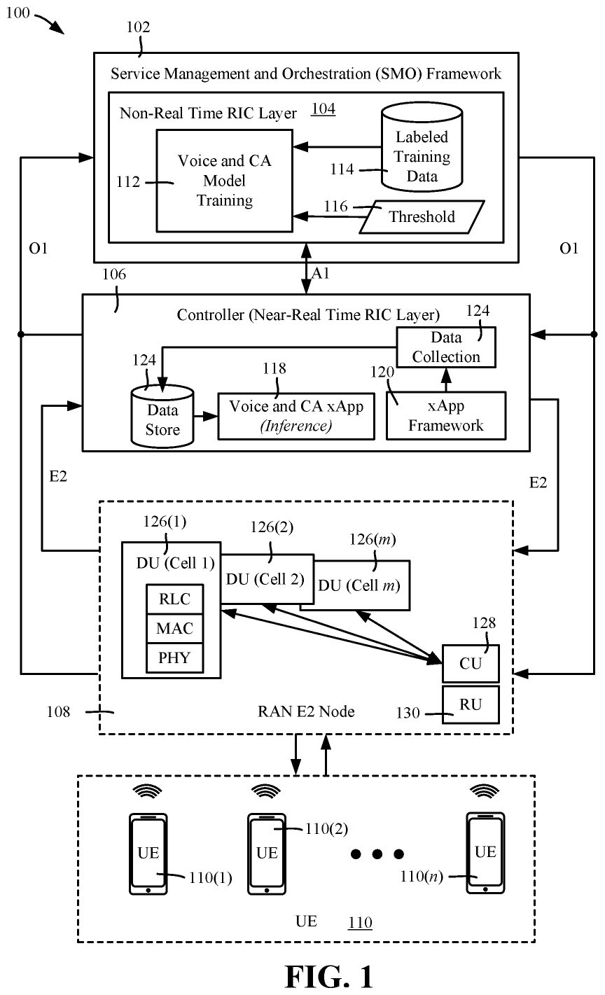

FIG. 1 is a block diagram representation of a system/architecture 100 for determining whether carrier aggregation will negatively impact voice service with respect to a user equipment (UE), and if so, to prevent usage of carrier aggregation in conjunction with the voice service. Otherwise, carrier aggregation can be used in conjunction with voice service simultaneously.

The example components of FIG. 1 are shown in an O-RAN compliant implementation, including a service management and orchestration (SMO) framework 102. In general, the SMO framework 102 acts as a management and orchestration layer that controls configuration and automation aspects of RAN (radio access network) and RIC (RAN Intelligent Controller) elements. For example, the non-real time RIC layer 104 onboards rApps (RAN applications).

As specified in O-RAN, in the example implementation of FIG. 1, the SMO framework 102 includes a non-real time RIC layer 104, which is coupled via O-RAN-defined A1 and O1 interfaces to a controller 106 (that is, the O-RAN-specified near-real time RIC layer). In turn, the near-real time controller 106 is coupled via the E2 interface to a RAN E2 node 108 that communicates with one or more UEs (collectively 110), shown in FIG. 1 as user equipment 110(1)-110(n).

Returning to the non-real time RIC layer 104, as shown in FIG. 1, among other functionality the non-real time RIC layer 104 includes a voice and carrier aggregation (CA) model training component 112 as described herein. In one example implementation described herein, the voice carrier aggregation model is a classification model, and more particularly a binary classification model, which is trained using collected labeled training data 114, including datasets that each include a voice quality metric score for a group of user equipment and network KPIs that existed at the time the score was determined. The voice quality metric score can be determined from objective network (e.g., buffer-related) data, such as packet delay data, packet jitter data, and packet loss data, e.g., such as the known “R-Factor” score for voice quality. It is also feasible for such data to be combined in some way with subjective data from listeners/simulated listeners that provide a voice quality estimate, e.g., a Mean Opinion Score (MOS).

In any event, each dataset of the labeled training data 114 includes an accompanying voice quality score, which can be evaluated with respect to threshold data 116. For example, a network service operator or the like can determine what threshold to set with respect to voice quality for a given classification model. As a simplified example, consider that the voice quality score ranges from 1 to 10 (with 1 being worst quality, 10 being best quality); one operator may define that a voice quality of 5 or better is sufficient for use in conjunction with carrier aggregation, while another may define that 7 or better is needed before voice can be used in conjunction with carrier aggregation. Note that even for the same network operator, this training threshold can vary geographically, such as one model for one area trained using its own threshold and labels, another model for another area trained using its own threshold and labels, and so on. Such a training can be performed based on the UEs, primary cell, secondary cell and the labels for each such area. Note that multiple models may be available for given area, such as one model for one quality of service (QOS) level, and another model for another quality of service level.

In the example implementation of FIG. 1, once a model is trained, the model can be operated in inference mode in the controller 106 (the O-RAN near-real time RIC layer). More particularly, the trained model can be implemented as an xApp to perform inference, shown in FIG. 1 as voice and CA xApp 118. In general, an xApp is an application deployed in the controller (near-real time) RIC 106 that handles optimizations or the like for specific use cases. Note that an xApp framework 120 exposes an API for xApps to subscribe on registered E2 nodes and configuration updates, whereby the voice and CA xApp 118 subscribes on E2 node key performance indicators (KPIs) as described herein, e.g., data collection (block 122) along with a data store 124 stores the KPIs collected from RAN E2 nodes, including the E2 node 108 depicted in FIG. 1. The data store 124 can also store subscription-related details, such as requested KPIs, accepted/failed requests and so on.

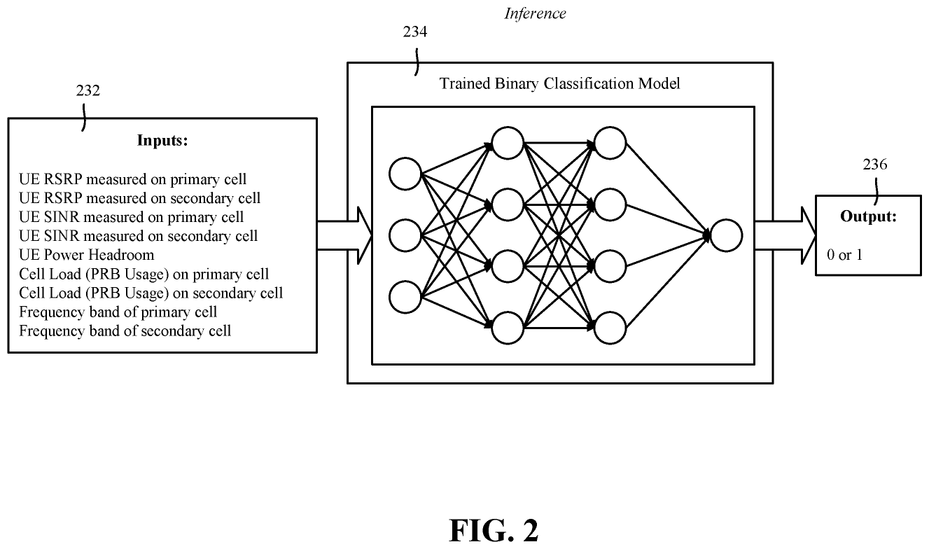

Thus, the voice and CA xApp 118 predicts at the inference level whether to apply carrier aggregation or not based on UE and network KPI input data, such as described with reference to FIG. 2. Then, once the inference is performed for a UE's KPIs with respect to the network KPIs, the voice and CA xApp 118 can output its decision (e.g., 0, representing no CA, or “No-Go” with respect to CA, or 1 representing yes CA, or “Go” with respect to CA) via the E2 interface to the RAN E2 node. For completeness, the RAN E2 node 108 is shown in FIG. 1 with a number of distributed units (DUs) 126(1)-126(m) (corresponding to cells 1−m) each coupled to a centralized unit (CU) 128, and a radio unit (RU) 130. For example, based on the decision from the voice and CA xApp 118, a distributed unit can instruct its corresponding primary cell base station (e.g., gNodeB, or gNB) serving a user equipment to have the user equipment activate or release a secondary cell configured or configurable for carrier aggregation.

FIG. 2 shows the input data 232 to a trained instance of a binary classification model 234, such as able to be implemented in the voice and CA xApp 118 of FIG. 1. As is understood, these correspond to the same input data parameters used in supervised training (minus the labels). As shown in the example of FIG. 2, the input data 232 can include, but is not limited to, current UE state data for a user equipment, which can include UE reference signal received power (RSRP) for a UE measured on (with respect to) the primary cell, UE RSRP measured on the secondary cell, UE signal-plus-interference-to-noise ratio (SINR) measured on the primary cell, UE SINR measured on the secondary cell, and UE power headroom. The network-related KPI input data 232 can include, but is not limited to, cell load (physical resource block (PRB) usage) on the primary cell, and cell load (PRB usage) on the secondary cell. The frequency band of the primary cell and the frequency band of the secondary cell are also input data in one or more implementations, as the frequency bands can influence voice quality.

In the example of FIG. 2, the classifier 234 is a binary classifier that outputs 0 or 1 (block 236), e.g., 0 represents “No-Go” (simultaneous CA is not allowed), while 1 represents “Go” (yes, simultaneous CA is allowed) with respect to CA. The model predicts based on block 232 input data, which in this example is UE radio conditions, UE transmission power remaining, cells' load data, and frequency bands. The voice CA xApp 118 (FIG. 1) in the near-real time RIC retrieves the network data including the KPIs, performs inference, and sends control actions for CA activation/deactivation, that is, outputs the inference from the model to activate or deactivate carrier aggregation.

Thus, in the example of FIG. 2, a supervised machine learning classifier decides whether the UE can use CA while maintaining voice calls or not use CA. FIG. 2 shows an example of a neural network that reads multiple features as input, and outputs one neuron that can be trained to predict whether the UE can perform CA or not. As described with reference to FIG. 1, the label (output) is obtained by setting a threshold on the voice quality KPI during training. If the voice quality data satisfies the threshold, then the training sample is labeled as 1 (“Go” for CA), otherwise the training sample is labeled as 0 (“No Go” for CA). The threshold value can be defined by the network operator, which can vary according to the cell conditions and/or other factors.

Note that a binary classifier is only one type of model that can be used, as many other supervised and non-supervised artificial intelligence/machine learning models can be trained based on similar input data. For example, rather than a binary classifier that inputs a threshold to compare during training, a model may be trained to output a voice quality score during inference, with the output score then compared (post-inference) to a specified threshold. In any event, the trained model is used in inference mode to predict whether a UE is capable of applying carrier aggregation while maintaining a voice calls at sufficiently good quality (that is, satisfies the defined voice quality threshold).

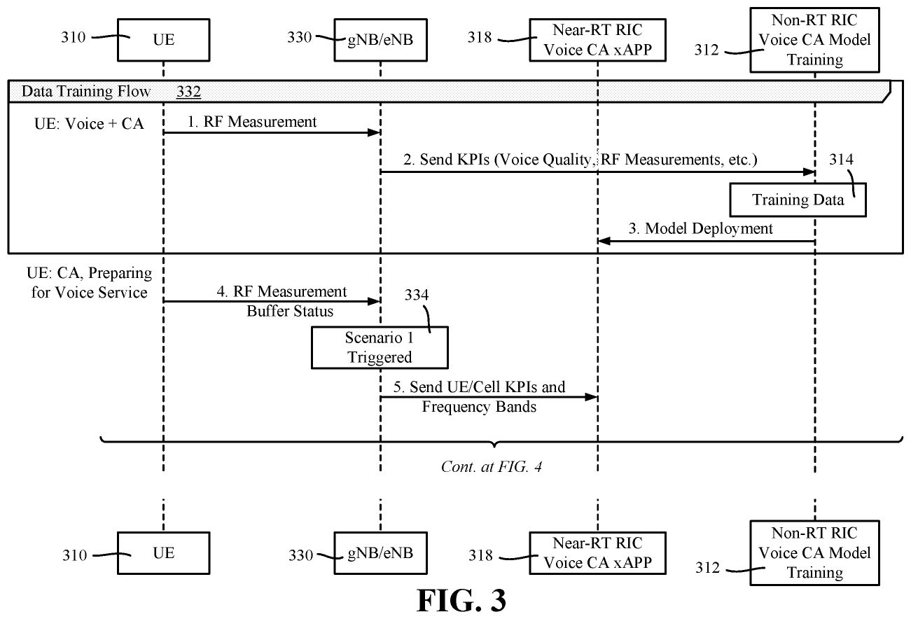

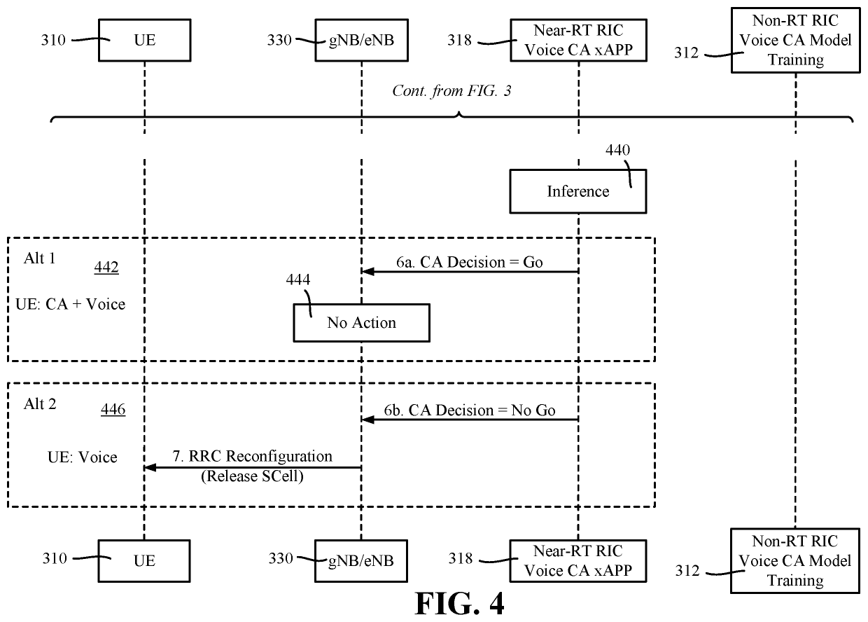

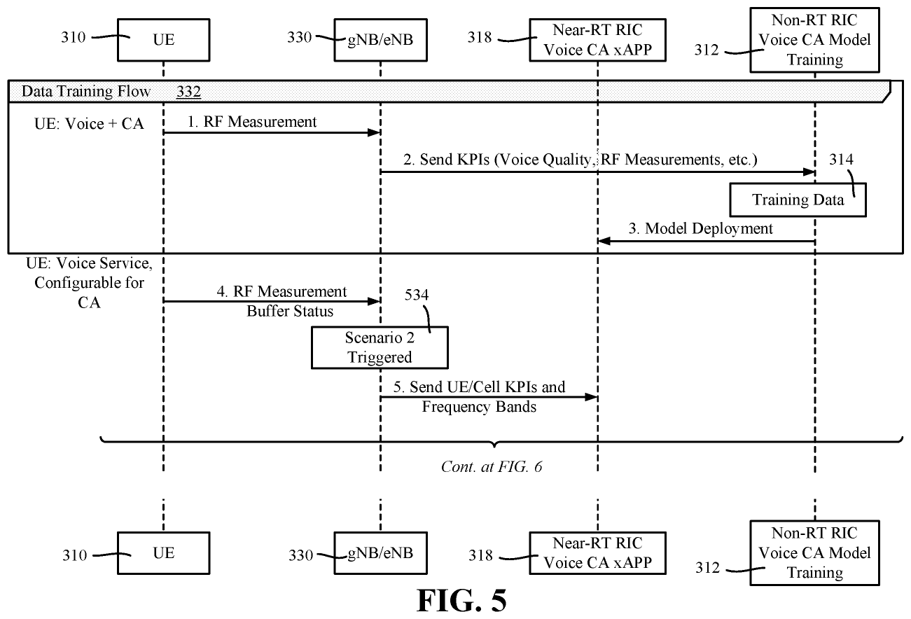

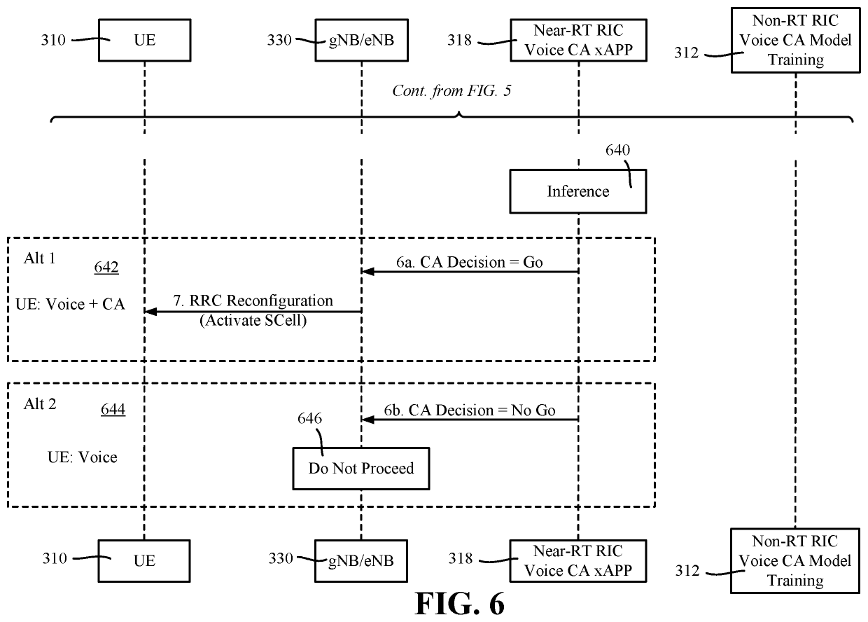

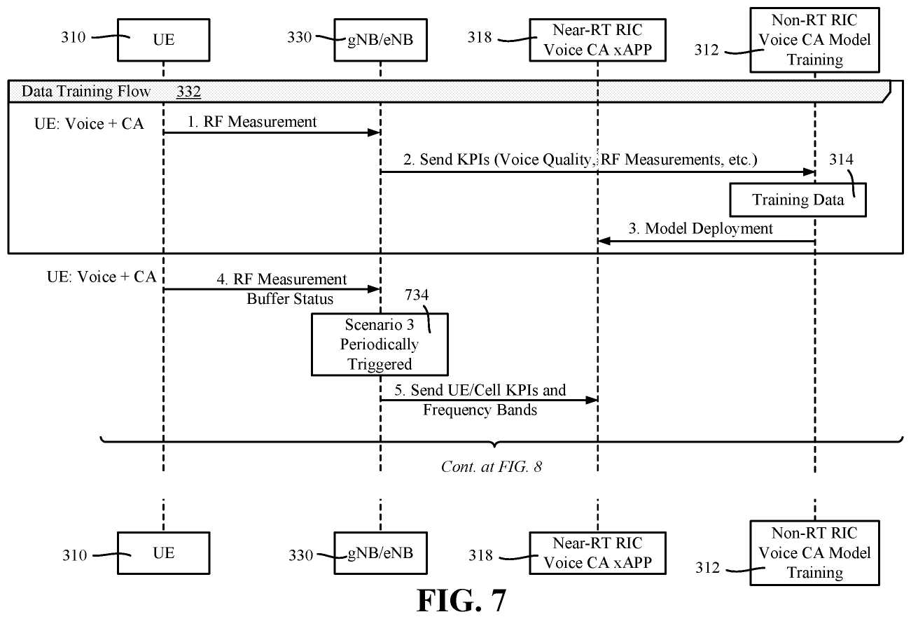

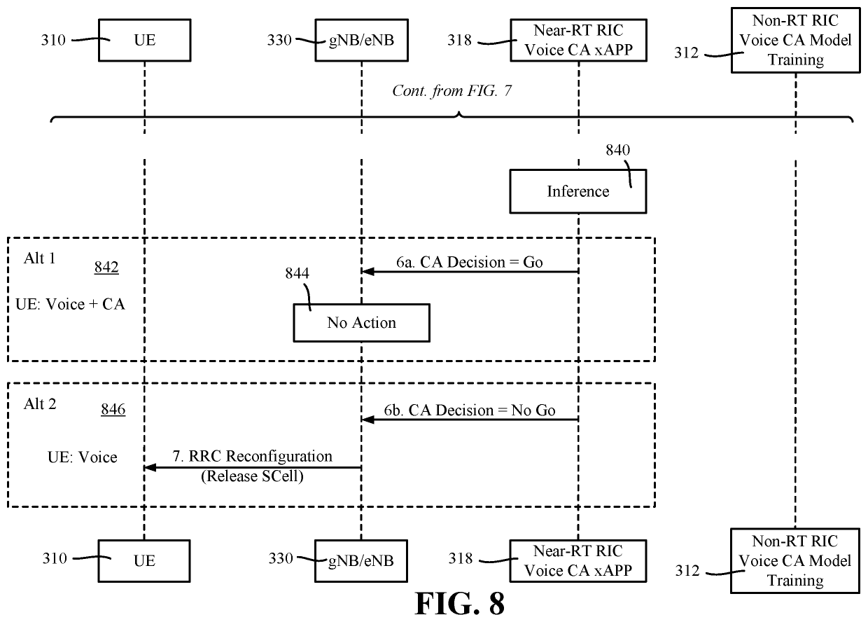

FIGS. 3 and 4, 5 and 6, and 7 and 8 are sequence/dataflow diagrams for three respective scenarios, namely a first scenario when a UE is using carrier aggregation and is preparing to have a voice service (FIGS. 3 and 4), a second scenario in which a UE currently has a voice service and carrier aggregation can be configured (should be initiated if allowed, FIGS. 5 and 6), and a third, monitoring scenario in which a UE is already operating with (is allowed to have) voice service in conjunction with (at the same time as) carrier aggregation (FIGS. 7 and 8). Note that the first and second scenarios are similar, as they only differ in what triggers the flow, in that the first scenario is triggered when preparing for voice service (with CA), while the second scenario is triggered when already using voice service with a possibility of using CA.

As shown in FIG. 3, the data training flow is depicted in block 332, in which RF measurement data is sent (arrow one (1)) from a UE 310 to a base station (gNB/eNB) 330. In turn, the base station 330 sends KPIs to an instance of a non-real time RIC voice and CA model training component 312 (arrow two (2)), which performs training based on training data 314 (and a defined threshold if binary classification is in use) that is suitable for the environment, e.g., a geographic area. Arrow three (3) represents the model being deployed into an instance of the near-real time RIC voice and CA xApp 318. Note that the data training flow 332 is the same in the scenarios of FIGS. 5 and 7, and is not described again herein for purposes of brevity. Further, training is only performed as needed, possibly only once, and thus the operations represented by arrows one (1) through three (3) are not again performed during what is likely to be the expected usage of the model in the three example scenarios.

As set forth above, the first and second scenarios are similar, other than FIG. 3 being triggered by preparing for voice service, and FIG. 5 being triggered by preparing for (the UE is configurable for carrier aggregation). Thus, arrow four (4) in both the first and the second scenarios represents the RF (radio frequency) measurement buffer status being sent from the UE 310 to the base station 330, wherein the RF (radio frequency) measurement buffer status is tied to the UE KPIs. Uplink buffer status reports measure the data that is buffered in the logical channel queues in the UE, and are used to provide support for QoS-aware packet scheduling. Typically, whether CA is to be activated depends on the size of the data in the buffer, that is, if the data size exceeds a specified threshold, CA will be activated; otherwise, it will remain inactive. Notwithstanding, as described herein, whether CA is activated (if not active) or released (if active) depends on the classifier's intelligent CA decision.

FIG. 3 shows the first scenario, scenario 1, being triggered at block 334. This results in the base station 330 sending (arrow five (5)) the input data (UE KPIs, cell KPIs and frequency bands) to the near-real time RIC voice and CA xApp 318. In other words, the voice and CA xApp in the near-real time RIC is triggered to fetch the UE KPIs, along with the cell KPIs and the frequency bands of each of the primary and secondary cells.

The process continues at FIG. 4, where block 440 represents the near-real time RIC voice and CA xApp 318 performing inference based on this data, by using the model trained in the non-real time RIC 104 of FIG. 1. The decision of the model (block 318) is relayed to the base station 330, which, if appropriate, takes action.

In a first alternative (arrow (6a)) represented in block 442, the inference based on the input data results in a carrier aggregation decision of CA=Go, that is, carrier aggregation is allowed because the estimated voice quality data from the input data is deemed by the classifier as sufficient to satisfy the voice quality threshold. Because carrier aggregation is already active in the first scenario of FIGS. 3 and 4, the first alternative takes no action (block 444), allowing carrier aggregation to continue to be used in conjunction with voice service, that is, the carrier aggregation state is maintained as operational for this UE.

In a second alternative (arrow (6b)) represented in block 446, the inference based on the input data results in a carrier aggregation decision of CA=No Go, that is, carrier aggregation is not allowed because the estimated voice quality data from the input data is deemed by the classifier as insufficient to satisfy the voice quality threshold. Because carrier aggregation is active in the first scenario of FIGS. 3 and 4, the second alternative performs an action (arrow seven (7)), in which the base station 330 instructs via a radio resource control (RRC) message to the UE 310 to remove the secondary cell (release SCell), whereby the carrier aggregation state is changed to non-operational for this UE.

FIG. 5 is similar to FIG. 3, except that voice service is already active, and the model's decision is whether to configure the UE (activate the secondary cell) for carrier aggregation. Thus, arrows one (1) through five (5) are not described again for purposes of brevity other than to note that arrow four (4) triggers the second scenario, scenario 2 (block 534), in this example.

The process continues at FIG. 6, where block 640 represents the near-real time RIC voice and CA xApp 318 performing inference based on the input data. The decision of the model (block 318) is relayed to the base station 330, which, if appropriate, takes action.

More particularly, in a first alternative (arrow (6a)) represented in block 642, the inference based on the input data results in a carrier aggregation decision of CA=Go, that is, carrier aggregation is allowed because the estimated voice quality data from the input data is deemed by the classifier as sufficient to satisfy the voice quality threshold. Because carrier aggregation is not already active in the second scenario of FIGS. 5 and 6, the first alternative performs an action (arrow seven (7)), in which the base station 330 instructs via an RRC message to the UE 310 to activate the secondary cell (activate SCell) for use in carrier activation.

In a second alternative (arrow (6b)) represented in block 644, the inference based on the input data results in a carrier aggregation decision of CA=No Go, that is, carrier aggregation is not allowed because the estimated voice quality data from the input data is deemed by the classifier as insufficient to satisfy the voice quality threshold. Because carrier aggregation is not active in the first scenario of FIGS. 3 and 4, the second alternative takes no action (does not proceed) at block 646, whereby carrier aggregation state is maintained as non-operational for this UE.

FIGS. 7 and 8 represent a third scenario, which can be performed following the decision of the first scenario or the second scenario, that is, whenever both voice and carrier aggregation are operating at the same time. In this scenario, monitoring is performed to determine whether the voice quality, based on the input data, has sufficiently degraded so as to no longer satisfy the voice quality data threshold. To this end, the inference at block 318 can be periodically triggered with updated input data, or triggered in some other way (e.g., one or more of the input data parameter values has sufficiently changed relative to previous value(s)).

FIG. 7 is similar to FIGS. 3 and 5, except that both voice service and carrier aggregation are already active for a UE, and the model's decision is whether to drop the carrier aggregation UE (release the secondary cell) for. Thus, arrows one (1) through five (5) are not described again for purposes of brevity other than to note that arrow four (4) triggers the third scenario, scenario 3 (block 734), in this example.

The process continues at FIG. 8, (which in this example is identical to FIG. 4 except in labeled numerals) where block 840 represents the near-real time RIC voice and CA xApp 318 performing inference based on this data, by using the model trained in the non-real time RIC 104 of FIG. 1. The decision of the model (block 318) is relayed to the base station 330, which, if appropriate, takes action.

In a first alternative (arrow (6a)) represented in block 842, the inference based on the input data results in a carrier aggregation decision of CA=Go, that is, carrier aggregation is allowed because the estimated voice quality data from the input data is deemed by the classifier as sufficient to satisfy the voice quality threshold. Because carrier aggregation is already active in the third scenario of FIGS. 7 and 8, the first alternative takes no action (block 844), allowing carrier aggregation to continue to be used in conjunction with voice service, that is, the carrier aggregation state is maintained as operational for this UE.

In a second alternative (arrow (6b)) represented in block 846, the inference based on the input data results in a carrier aggregation decision of CA=No Go, that is, carrier aggregation is not allowed because the estimated voice quality data from the input data is deemed by the classifier as insufficient to satisfy the voice quality threshold. Because carrier aggregation is active in the third scenario of FIGS. 7 and 8, the second alternative performs an action (arrow seven (7)), in which the base station 330 instructs via a radio resource control (RRC) message to the UE 310 to remove the secondary cell (release SCell), whereby the carrier aggregation state is changed to non-operational for this UE.

Although not explicitly depicted in a sequence/dataflow diagram, it is understood that monitoring can occur with respect to changing a non-operational state of carrier aggregation to operational, that is, it is feasible to periodically check whether updated input data has changed such that carrier aggregation should be activated. Thus, the example operations of FIG. 6 can be executed, such as periodically during a voice call, after previously receiving a “No Go” carrier aggregation decision. Note that the time period for checking for CA when only voice is currently active need not be the same monitoring time period as in FIG. 8 (when both voice and CA are active), and that something other than periodic monitoring may be used to trigger the “check whether CA with voice now has acceptable voice quality” operations.

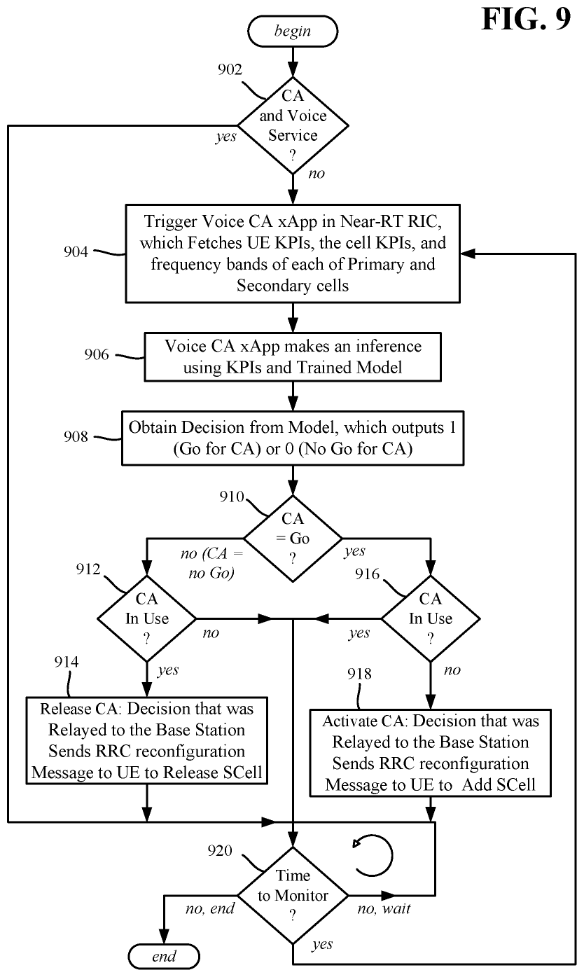

FIG. 9 is a flow diagram of example operations summarizing the above scenarios and dataflows, beginning at operation 902 which represents whether the third scenario is currently active, that is, CA and voice service are both in use. If so, operation 902 branches to operation 920 to monitor for whether CA needs to be released, which is periodic monitoring (waiting until the time to monitor is reached) in this example. Note that operation 920 allows for another alternative, namely ending the flow, such as if the user ends the voice call.

If both CA and voice are not in use, operation 904 represents triggering the voice and CA xApp, which fetches UE KPIS, the cell KPIS, and frequency bands of each of the primary and secondary cells. Operation 906 represents the inference decision, which is obtained (by the base station)” from the voice and CA xApp at operation 908.

If the CA decision is “No Go” as evaluated at operation 910, operation 912 is performed in this example to determine whether CA is already in use. If not, nothing needs to be done, otherwise operation 912 branches to operation 914, where the decision results in the base station sending an RRC message to the UE to release the secondary cell, thereby deactivating carrier aggregation.

Returning to operation 910, if the CA decision is “Go,” operation 916 is performed, which evaluates whether CA is already in use. If so, nothing needs to be done, otherwise operation 916 branches to operation 918, where the decision results in the base station sending an RRC message to the UE to add the secondary cell, thereby activating carrier aggregation.

In the example of FIG. 9, monitoring (including operation 920) is performed regardless of whether only voice is active, or whether both voice and carrier aggregation are active. Note that the periodic times can be different for voice only (e.g., every X milliseconds) compared to both voice and carrier aggregation (e.g., every Y milliseconds). Notwithstanding, it is alternatively feasible to only perform monitoring when both voice and carrier aggregation were previously active (as in the third scenario in the example of FIGS. 7 and 8). In other words, monitoring can only be performed to evaluate whether carrier aggregation needs to be deactivated, and not with respect to being activated. If only monitoring for deactivating carrier aggregation is being used, the “no” branch following operation 912, or the process following operation 914 can wait and do nothing further until voice service ends. The process can be resumed when any of scenarios 1-3 are triggered (arrow four (4) of FIG. 3, FIG. 5 or FIG. 7).

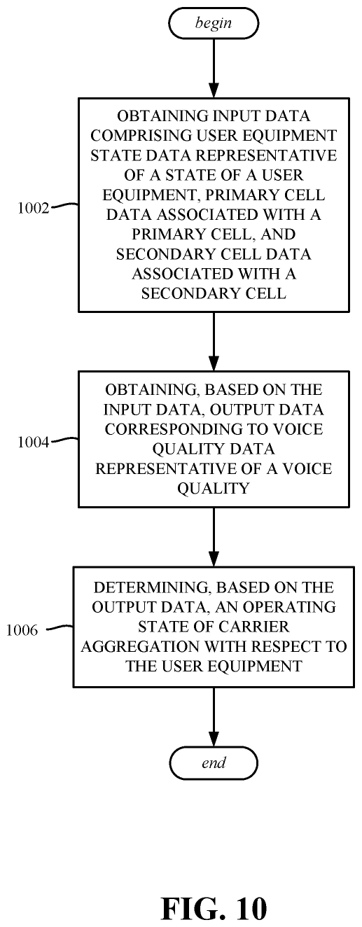

One or more example embodiments can be embodied in a system, such as represented in the example operations of FIG. 10, and for example can include a memory that stores computer executable components and/or operations, and a processor that executes computer executable components and/or operations stored in the memory. Example operations can include operation 1002, which represents obtaining input data comprising user equipment state data representative of a state of a user equipment, primary cell data associated with a primary cell, and secondary cell data associated with a secondary cell. Example operation 1004 represents obtaining, based on the input data, output data corresponding to voice quality data representative of a voice quality. Example operation 1004 represents determining, based on the output data, an operating state of carrier aggregation with respect to the user equipment.

Obtaining, based on the input data, the output data corresponding to the voice quality data can include inputting the input data into a binary classifier that outputs a first value indicating that carrier aggregation used in conjunction with voice service is likely to result in acceptable voice quality, or a second value indicating that the carrier aggregation used in conjunction with the voice service is likely to result in unacceptable voice quality.

Further operations can include training the binary classifier based on whether voice quality metric data satisfies a defined threshold value, the voice quality metric data based on at least one of: packet delay data representative of a packet delay, packet jitter data representative of packet jitter, or packet loss data representative of packet loss.

The user equipment state data can include at least one of: user equipment reference signal received power data representative of a first reference signal received power of the user equipment measured with respect to the primary cell, user equipment reference signal received power data representative of a second reference signal received power of the user equipment measured with respect to the secondary cell, user equipment signal-plus-interference-to-noise ratio data representative of a first signal-plus-interference-to-noise ratio associated with the user equipment measured with respect to the primary cell, user equipment signal-plus-interference-to-noise ratio data representative of a second signal-plus-interference-to-noise ratio associated with the user equipment measured with respect to the secondary cell, or user equipment power headroom data representative of a power headroom associated with the user equipment.

The primary cell data associated with the primary cell can include at least one of: cell load data representative of a cell load on the primary cell, or frequency band data representative of a frequency band used by the primary cell.

The secondary cell data associated with the secondary cell can include at least one of: cell load data on the secondary cell, or frequency band data of the secondary cell.

The user equipment can be operating with carrier aggregation and can be preparing to use voice service, the output data can correspond to voice quality data that does not satisfy a defined voice quality threshold value, and determining the operating state of the carrier aggregation with respect to the user equipment can include taking an action to release the carrier aggregation with respect to the user equipment.

The user equipment can be operating with carrier aggregation and can be preparing to use voice service, the output data can correspond to voice quality data that satisfies a defined voice quality threshold value, and determining the operating state of the carrier aggregation with respect to the user equipment can include allowing the carrier aggregation to continue with respect to the user equipment.

The user equipment can be operating with voice service and can be configurable to use carrier aggregation, the output data can correspond to voice quality data that satisfies a defined voice quality threshold value, and determining the operating state of the carrier aggregation with respect to the user equipment can include taking an action to activate the carrier aggregation with respect to the user equipment.

The user equipment can be operating with voice service and can be configurable to use carrier aggregation, the output data can correspond to voice quality data that does not satisfy a defined voice quality threshold value, and determining the operating state of the carrier aggregation with respect to the user equipment can include bypassing configuring the carrier aggregation with respect to the user equipment.

The user equipment can be operating with carrier aggregation and voice service, the output data can be first output data corresponding to first voice quality data, and further operations can include monitoring second output data corresponding to second voice quality data to determine whether the user equipment is to continue operating with the carrier aggregation and the voice service.

Further operations can include, in response to the monitoring of the second output data determining that the user equipment is not to continue operating with the carrier aggregation and the voice service, taking an action to release the carrier aggregation.

The user equipment can be operating with voice service and can be not operating with carrier aggregation, the output data can be first output data corresponding to first voice quality data representative of a first voice quality, and further operations can include monitoring second output data corresponding to second voice quality data representative of a second voice quality to determine whether the user equipment is allowed to operate with the carrier aggregation in conjunction with the voice service.

Further operations can include, in response to the monitoring of the second output data determining that the user equipment is allowed to operate with the carrier aggregation in conjunction with the voice service, taking an action to activate the carrier aggregation with respect to the user equipment.

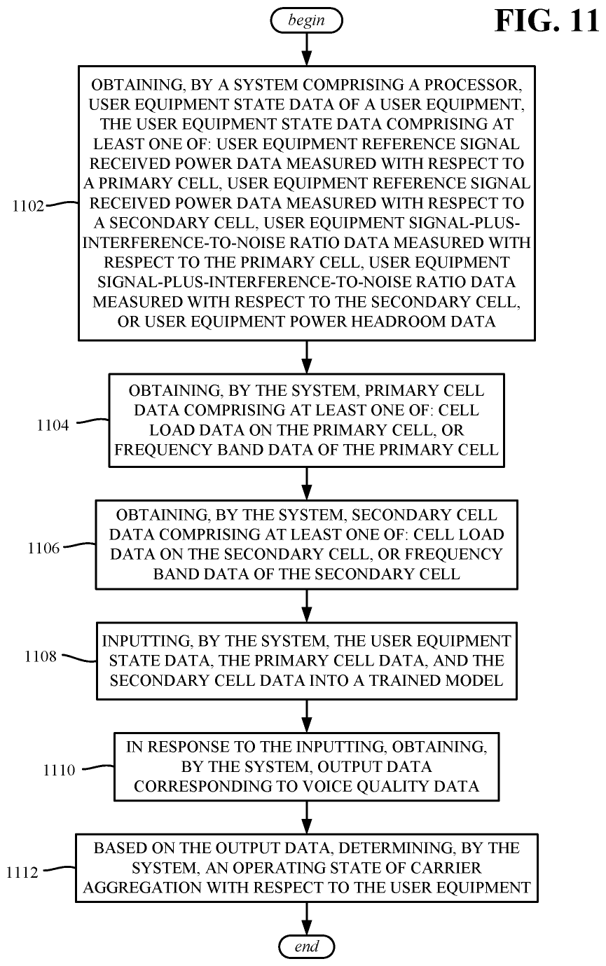

One or more example embodiments, such as corresponding to example operations of a method, are represented in FIG. 11. Example operation 1102 represents obtaining, by a system comprising a processor, user equipment state data of a user equipment, the user equipment state data comprising at least one of: user equipment reference signal received power data measured with respect to a primary cell, user equipment reference signal received power data measured with respect to a secondary cell, user equipment signal-plus-interference-to-noise ratio data measured with respect to the primary cell, user equipment signal-plus-interference-to-noise ratio data measured with respect to the secondary cell, or user equipment power headroom data. Example operation 1104 represents obtaining, by the system, primary cell data comprising at least one of: cell load data on the primary cell, or frequency band data of the primary cell. Example operation 1106 represents obtaining, by the system, secondary cell data comprising at least one of: cell load data on the secondary cell, or frequency band data of the secondary cell. Example operation 1108 represents inputting, by the system, the user equipment state data, the primary cell data, and the secondary cell data into a trained model. Example operation 1110 represents in response to the inputting, obtaining, by the system, output data corresponding to voice quality data. Example operation 1112 represents based on the output data, determining, by the system, an operating state of carrier aggregation with respect to the user equipment.

The user equipment can be operating with carrier aggregation and can be preparing to use voice service, the output data can correspond to voice quality data that does not satisfy a defined voice quality threshold value, and determining the operating state of the carrier aggregation with respect to the user equipment can include facilitating release of the carrier aggregation with respect to the user equipment.

The user equipment can be operating with voice service and can be configurable to use carrier aggregation, the output data can correspond to voice quality data that satisfies a defined voice quality threshold value, and determining the operating state of the carrier aggregation with respect to the user equipment can include facilitating activation of the carrier aggregation with respect to the user equipment.

The user equipment can be operating with voice service and can be operating with carrier aggregation, the user equipment state data can be first user equipment state data, the primary cell data can be first primary cell data, the secondary cell data can be first secondary cell data, the output data can be first output data corresponding to first voice quality data, and further operations can include monitoring, by the system, second user equipment state data, second primary cell data, and second secondary cell data, in response to the monitoring, determining, by the system, that the user equipment is not to operate with the carrier aggregation in conjunction with the voice service, and in response to the determining that the user equipment is not to operate with the carrier aggregation in conjunction with the voice service, facilitating, by the system, the release of the carrier aggregation with respect to the user equipment.

Facilitating the release of the carrier aggregation can include instructing a base station to communicate a radio resource control reconfiguration message to the user equipment to release the secondary cell.

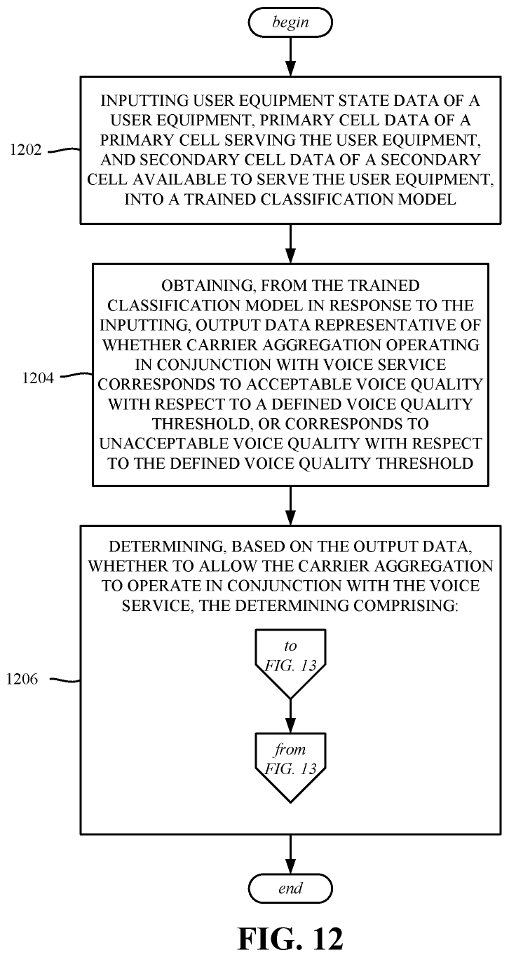

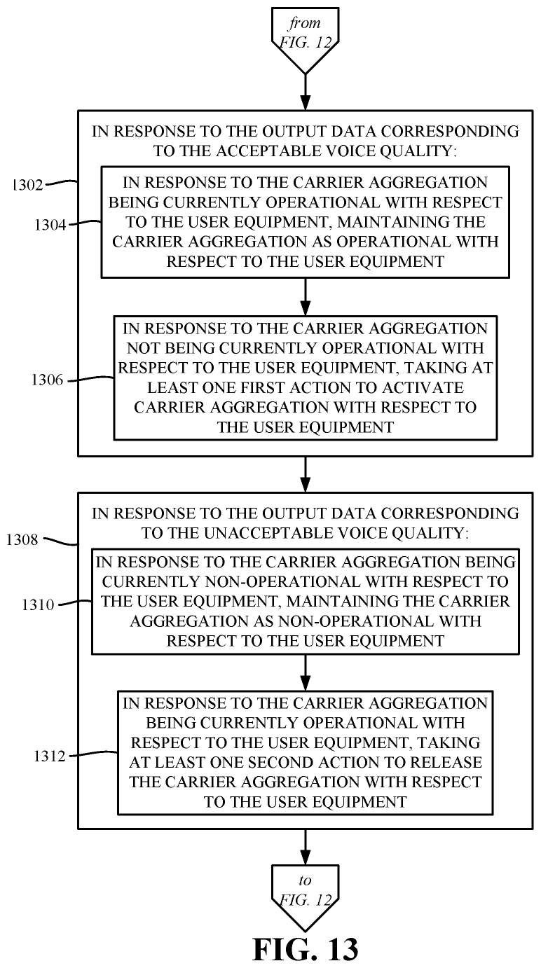

FIGS. 12 and 13 summarize various example operations, e.g., corresponding to a machine-readable medium, comprising executable instructions that, when executed by a processor of network equipment, facilitate performance of operations. Example operation 1202 of FIG. 12 represents inputting user equipment state data of a user equipment, primary cell data of a primary cell serving the user equipment, and secondary cell data of a secondary cell available to serve the user equipment, into a trained classification model. Example operation 1204 represents obtaining, from the trained classification model in response to the inputting, output data representative of whether carrier aggregation operating in conjunction with voice service corresponds to acceptable voice quality with respect to a defined voice quality threshold, or corresponds to unacceptable voice quality with respect to the defined voice quality threshold. Example operation 1206 represents determining, based on the output data, whether to allow the carrier aggregation to operate in conjunction with the voice service, in which the determining can include the operations of FIG. 13. Example operation 1302 of FIG. 13 represents, in response to the output data corresponding to the acceptable voice quality, in response to the carrier aggregation being currently operational with respect to the user equipment, maintaining the carrier aggregation as operational with respect to the user equipment (example operation 1304), and in response to the carrier aggregation not being currently operational with respect to the user equipment, taking at least one first action to activate carrier aggregation with respect to the user equipment (example operation 1306). Example operation 1308 of FIG. 13 represents, in response to the output data corresponding to the unacceptable voice quality, in response to the carrier aggregation being currently non-operational with respect to the user equipment, maintaining the carrier aggregation as non-operational with respect to the user equipment (example operation 1310), and in response to the carrier aggregation being currently operational with respect to the user equipment, taking at least one second action to release the carrier aggregation with respect to the user equipment (example operation 1312).

The user equipment can be operating with the voice service in conjunction with the carrier aggregation, the user equipment state data can be first user equipment state data, the second primary cell data can be first primary cell data, the secondary cell data can be first secondary cell data, the output data can be first output data, and further operations can include monitoring second output data based on second user equipment state data, second primary cell data, and second secondary cell data, determining, based on the second output data, that the voice service corresponds to unacceptable voice quality, and in response to the determining that the voice service corresponds to unacceptable voice quality, taking at least one second action to release the carrier aggregation with respect to the user equipment.

As can be seen, the technology described herein facilitates intelligent, dynamic and proactive carrier aggregation management, based on real time network and UE KPIs, for users requesting simultaneous voice and data sessions. Significantly, the technology described herein, which can be implemented in an ORAN-compliant system, allows the significant performance improvements of carrier aggregation whenever voice quality is not compromised, resulting in an improved experience that helps achieve service level agreement requirements of UEs, via simultaneous multiple component carriers that increase the overall data rate and capacity of the network. In situations where carrier aggregation can harm the performance of voice over LTE/new radio calls, which can lead to call drops and degraded service, the technology described herein can deactivate carrier aggregation in near-real time fashion. The technology described herein works with different scenarios depending on multiple factors that result in different voice degradation probabilities, such as real-time fluctuations in traffic demand and radio conditions, which make static carrier activation decisions (as currently done) far from optimal. The technology described herein maintains voice quality while applying carrier aggregation for better data rates and spectrum utilization whenever possible. One implementation is based on a supervised machine learning model that allows users with voice service and data simultaneously to use CA and increase their data rate when good RF and cell conditions are present.

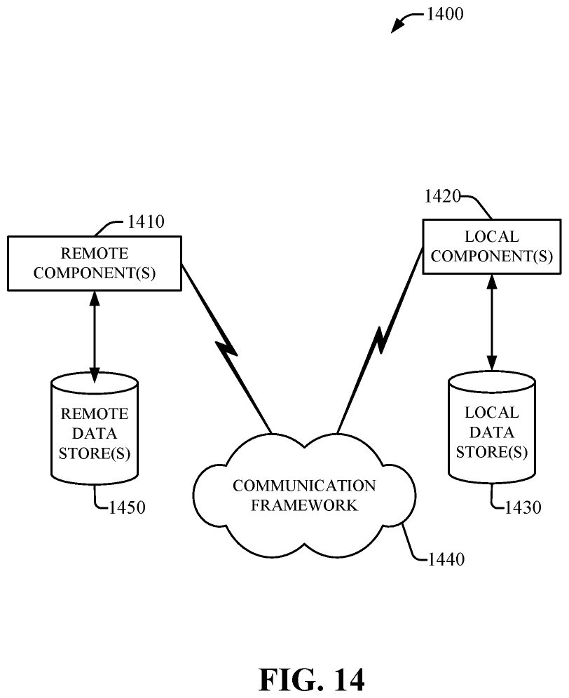

FIG. 14 is a schematic block diagram of a computing environment 1400 with which the disclosed subject matter can interact. The system 1400 comprises one or more remote component(s) 1410. The remote component(s) 1410 can be hardware and/or software (e.g., threads, processes, computing devices). In some embodiments, remote component(s) 1410 can be a distributed computer system, connected to a local automatic scaling component and/or programs that use the resources of a distributed computer system, via communication framework 1440. Communication framework 1440 can comprise wired network devices, wireless network devices, mobile devices, wearable devices, radio access network devices, gateway devices, femtocell devices, servers, etc.

The system 1400 also comprises one or more local component(s) 1420. The local component(s) 1420 can be hardware and/or software (e.g., threads, processes, computing devices). In some embodiments, local component(s) 1420 can comprise an automatic scaling component and/or programs that communicate/use the remote resources 1410, etc., connected to a remotely located distributed computing system via communication framework 1440.

One possible communication between a remote component(s) 1410 and a local component(s) 1420 can be in the form of a data packet adapted to be transmitted between two or more computer processes. Another possible communication between a remote component(s) 1410 and a local component(s) 1420 can be in the form of circuit-switched data adapted to be transmitted between two or more computer processes in radio time slots. The system 1400 comprises a communication framework 1440 that can be employed to facilitate communications between the remote component(s) 1410 and the local component(s) 1420, and can comprise an air interface, e.g., Uu interface of a UMTS network, via a long-term evolution (LTE) network, etc. Remote component(s) 1410 can be operably connected to one or more remote data store(s) 1450, such as a hard drive, solid state drive, SIM card, device memory, etc., that can be employed to store information on the remote component(s) 1410 side of communication framework 1440. Similarly, local component(s) 1420 can be operably connected to one or more local data store(s) 1430, that can be employed to store information on the local component(s) 1420 side of communication framework 1440.

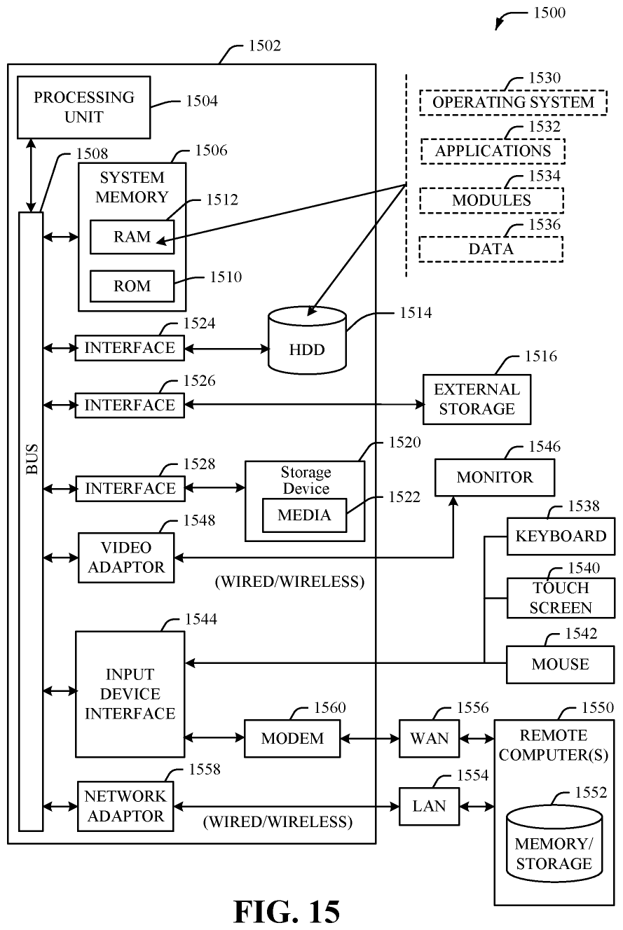

In order to provide additional context for various embodiments described herein, FIG. 15 and the following discussion are intended to provide a brief, general description of a suitable computing environment 1500 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 15, the example environment 1500 for implementing various embodiments of the example embodiments described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), and can include one or more external storage devices 1516 (e.g., a magnetic floppy disk drive (FDD) 1516, a memory stick or flash drive reader, a memory card reader, etc.). While the internal HDD 1514 is illustrated as located within the computer 1502, the internal HDD 1514 can also be configured for external use in a suitable chassis (not shown). Additionally, while not shown in environment 1500, a solid state drive (SSD) could be used in addition to, or in place of, an HDD 1514.

Other internal or external storage can include at least one other storage device 1520 with storage media 1522 (e.g., a solid state storage device, a nonvolatile memory device, and/or an optical disk drive that can read or write from removable media such as a CD-ROM disc, a DVD, a BD, etc.). The external storage 1516 can be facilitated by a network virtual machine. The HDD 1514, external storage device(s) 1516 and storage device (e.g., drive) 1520 can be connected to the system bus 1508 by an HDD interface 1524, an external storage interface 1526 and a drive interface 1528, respectively.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1594 serial port, a game port, a USB port, an IR interface, a BLUETOOTH® interface, etc.

A monitor 1546 or other type of display device can be also connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired and/or wireless communications to one or more remote computers, such as a remote computer(s) 1550. The remote computer(s) 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 and/or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 can be connected to the local network 1554 through a wired and/or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the Internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. It will be appreciated that the network connections shown are examples and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 and/or modem 1560, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a processor; and
a memory that stores executable instructions that, when executed by the processor, facilitate performance of operations, the operations comprising:
obtaining input data comprising user equipment state data representative of a state of a user equipment, primary cell data associated with a primary cell, and secondary cell data associated with a secondary cell;
obtaining, based on the input data, output data corresponding to voice quality data representative of a voice quality; and
determining, based on the output data, an operating state of carrier aggregation with respect to the user equipment.

2. The system of claim 1, wherein the obtaining, based on the input data, the output data corresponding to the voice quality data comprises inputting the input data into a binary classifier that outputs a first value indicating that carrier aggregation used in conjunction with voice service is likely to result in acceptable voice quality, or a second value indicating that the carrier aggregation used in conjunction with the voice service is likely to result in unacceptable voice quality.

3. The system of claim 2, wherein the operations further comprise training the binary classifier based on whether voice quality metric data satisfies a defined threshold value, the voice quality metric data based on at least one of: packet delay data representative of a packet delay, packet jitter data representative of packet jitter, or packet loss data representative of packet loss.

4. The system of claim 1, wherein the user equipment state data comprises at least one of: user equipment reference signal received power data representative of a first reference signal received power of the user equipment measured with respect to the primary cell, user equipment reference signal received power data representative of a second reference signal received power of the user equipment measured with respect to the secondary cell, user equipment signal-plus-interference-to-noise ratio data representative of a first signal-plus-interference-to-noise ratio associated with the user equipment measured with respect to the primary cell, user equipment signal-plus-interference-to-noise ratio data representative of a second signal-plus-interference-to-noise ratio associated with the user equipment measured with respect to the secondary cell, or user equipment power headroom data representative of a power headroom associated with the user equipment.

5. The system of claim 1, wherein the primary cell data associated with the primary cell comprises at least one of: cell load data representative of a cell load on the primary cell, or frequency band data representative of a frequency band used by the primary cell.

6. The system of claim 1, wherein the secondary cell data associated with the secondary cell comprises at least one of: cell load data on the secondary cell, or frequency band data of the secondary cell.

7. The system of claim 1, wherein the user equipment is operating with carrier aggregation and is preparing to use voice service, wherein the output data corresponds to voice quality data that does not satisfy a defined voice quality threshold value, and wherein the determining of the operating state of the carrier aggregation with respect to the user equipment comprises taking an action to release the carrier aggregation with respect to the user equipment.

8. The system of claim 1, wherein the user equipment is operating with carrier aggregation and is preparing to use voice service, wherein the output data corresponds to voice quality data that satisfies a defined voice quality threshold value, and wherein the determining of the operating state of the carrier aggregation with respect to the user equipment comprises allowing the carrier aggregation to continue with respect to the user equipment.

9. The system of claim 1, wherein the user equipment is operating with voice service and is configurable to use carrier aggregation, wherein the output data corresponds to voice quality data that satisfies a defined voice quality threshold value, and wherein the determining of the operating state of the carrier aggregation with respect to the user equipment comprises taking an action to activate the carrier aggregation with respect to the user equipment.

10. The system of claim 1, wherein the user equipment is operating with voice service and is configurable to use carrier aggregation, wherein the output data corresponds to voice quality data that does not satisfy a defined voice quality threshold value, and wherein the determining of the operating state of the carrier aggregation with respect to the user equipment comprises bypassing configuring the carrier aggregation with respect to the user equipment.

11. The system of claim 1, wherein the user equipment is operating with carrier aggregation and voice service, wherein the output data is first output data corresponding to first voice quality data, and wherein the operations further comprise monitoring second output data corresponding to second voice quality data to determine whether the user equipment is to continue operating with the carrier aggregation and the voice service, and, in response to the monitoring of the second output data determining that the user equipment is not to continue operating with the carrier aggregation and the voice service, taking an action to release the carrier aggregation.

12. The system of claim 1, wherein the user equipment is operating with voice service and not operating with carrier aggregation, wherein the output data is first output data corresponding to first voice quality data representative of a first voice quality, and wherein the operations further comprise monitoring second output data corresponding to second voice quality data representative of a second voice quality to determine whether the user equipment is allowed to operate with the carrier aggregation in conjunction with the voice service.

13. The system of claim 12, wherein the operations further comprise, in response to the monitoring of the second output data determining that the user equipment is allowed to operate with the carrier aggregation in conjunction with the voice service, taking an action to activate the carrier aggregation with respect to the user equipment.

14. A method, comprising:
obtaining, by a system comprising a processor, user equipment state data of a user equipment, the user equipment state data comprising at least one of: user equipment reference signal received power data measured with respect to a primary cell, user equipment reference signal received power data measured with respect to a secondary cell, user equipment signal-plus-interference-to-noise ratio data measured with respect to the primary cell, user equipment signal-plus-interference-to-noise ratio data measured with respect to the secondary cell, or user equipment power headroom data;
obtaining, by the system, primary cell data comprising at least one of: cell load data on the primary cell, or frequency band data of the primary cell;
obtaining, by the system, secondary cell data comprising at least one of: cell load data on the secondary cell, or frequency band data of the secondary cell;
inputting, by the system, the user equipment state data, the primary cell data, and the secondary cell data into a trained model;
in response to the inputting, obtaining, by the system, output data corresponding to voice quality data; and
based on the output data, determining, by the system, an operating state of carrier aggregation with respect to the user equipment.

15. The method of claim 14, wherein the user equipment is operating with carrier aggregation and is preparing to use voice service, wherein the output data corresponds to voice quality data that does not satisfy a defined voice quality threshold value, and wherein the determining of the operating state of the carrier aggregation with respect to the user equipment comprises facilitating release of the carrier aggregation with respect to the user equipment.

16. The method of claim 14, wherein the user equipment is operating with voice service and is configurable to use carrier aggregation, wherein the output data corresponds to voice quality data that satisfies a defined voice quality threshold value, and wherein the determining of the operating state of the carrier aggregation with respect to the user equipment comprises facilitating activation of the carrier aggregation with respect to the user equipment.

17. The method of claim 14, wherein the user equipment is operating with voice service and is operating with carrier aggregation, wherein the user equipment state data is first user equipment state data, wherein the primary cell data is first primary cell data, wherein the secondary cell data is first secondary cell data, wherein the output data is first output data corresponding to first voice quality data, and further comprising:
monitoring, by the system, second user equipment state data, second primary cell data, and second secondary cell data,
in response to the monitoring, determining, by the system, that the user equipment is not to operate with the carrier aggregation in conjunction with the voice service, and
in response to the determining that the user equipment is not to operate with the carrier aggregation in conjunction with the voice service, facilitating, by the system, the release of the carrier aggregation with respect to the user equipment.

18. The method of claim 17, wherein the facilitating of the release of the carrier aggregation comprises instructing a base station to communicate a radio resource control reconfiguration message to the user equipment to release the secondary cell.

19. A non-transitory machine-readable medium, comprising executable instructions that, when executed by at least one processor of network equipment, facilitate performance of operations, the operations comprising:
inputting user equipment state data of a user equipment, primary cell data of a primary cell serving the user equipment, and secondary cell data of a secondary cell available to serve the user equipment, into a trained classification model;
obtaining, from the trained classification model in response to the inputting, output data representative of whether carrier aggregation operating in conjunction with voice service corresponds to acceptable voice quality with respect to a defined voice quality threshold, or corresponds to unacceptable voice quality with respect to the defined voice quality threshold; and
determining, based on the output data, whether to allow the carrier aggregation to operate in conjunction with the voice service, the determining comprising:
in response to the output data corresponding to the acceptable voice quality:
in response to the carrier aggregation being currently operational with respect to the user equipment, maintaining the carrier aggregation as operational with respect to the user equipment; and
in response to the carrier aggregation not being currently operational with respect to the user equipment, taking at least one first action to activate carrier aggregation with respect to the user equipment;
and
in response to the output data corresponding to the unacceptable voice quality:
in response to the carrier aggregation being currently non-operational with respect to the user equipment, maintaining the carrier aggregation as non-operational with respect to the user equipment; and
in response to the carrier aggregation being currently operational with respect to the user equipment, taking at least one second action to release the carrier aggregation with respect to the user equipment.

20. The non-transitory machine-readable medium of claim 19, wherein the user equipment is operating with the voice service in conjunction with the carrier aggregation, wherein the user equipment state data is first user equipment state data, wherein the second primary cell data is first primary cell data, wherein the secondary cell data is first secondary cell data, wherein the output data is first output data, and wherein the operations further comprise:
monitoring second output data based on second user equipment state data, second primary cell data, and second secondary cell data;
determining, based on the second output data, that the voice service corresponds to unacceptable voice quality; and
in response to the determining that the voice service corresponds to unacceptable voice quality, taking at least one second action to release the carrier aggregation with respect to the user equipment.
